(19) United States
(12) Patent Application Publication
(10) Pub. No.: US 2025/0149210 A1
(43) Pub. Date: May 8, 2025

(54) HIGH-POWER THIN FILM RESISTOR AND METHOD OF MANUFACTURING THEREOF

(71) Applicant: YAGEO CORPORATION, Kaohsiung City (TW)

(72) Inventors: Shen-Li HSIAO, Kaohsiung City (TW); Po-Hsun SHIH, Kaohsiung City (TW); Miao-Ling SHEN, Kaohsiung City (TW)

(21) Appl. No.: 18/656,606

(22) Filed: May 7, 2024

(30) Foreign Application Priority Data
Nov. 2, 2023 (TW) 112142216

(51) Int. Cl. H01C 7/00; H01C 1/14; H01C 17/28

(52) U.S. Cl. CPC H01C 7/006; H01C 1/14; H01C 17/288

(57) ABSTRACT

A high-power thin film resistor includes a substrate, a resistance layer, an internal electrode layer, a passivation layer and a thermal conductive layer. The resistance layer is disposed on the substrate, and the internal electrode layer has a middle internal electrode area and two terminal internal electrode areas. The resistance layer is divided into a middle resistance area and two terminal resistance areas by the middle internal electrode area and the two terminal internal electrode areas. The passivation layer covers portions of the resistance layer and the internal electrode layer. The thermal conductive layer is disposed on the passivation layer, wherein the thermal conductive layer has two thermal conductors and a gap between the two thermal conductors. The middle internal resistance area and the two terminal resistance areas form a series resistance, and the two terminal resistance areas have the same resistance value.

### RELATED APPLICATIONS

This application claims priority to Taiwan Application Serial Number 112142216, filed Nov. 2, 2023, which is herein incorporated by reference.

### BACKGROUND

### Technical Field

The invention relates to a resistor and a method of manufacturing thereof, and especially relates to a high-power thin film resistor and a method of manufacturing thereof.

### Description of Related Art

In a conventional method of manufacturing high-power thin film resistors, a layer of alloy resistance film is sputtered on a substrate, and a pair of internal terminal electrodes is formed on both terminals by printing or electroplating processes. Then, an insulating protection layer is formed to cover portions of the alloy resistance film and the internal terminal electrodes, thereby preventing the alloy resistance film from suffering environment polluted or damaged. Finally, an electroplating process is used to form a pair of external electrodes used for welding.

However, an aluminum nitride substrate or a passivated aluminum substrate used in the high-power thin film resistors will make it difficult to enable other alloy metal materials to adhere to the substrate due to the surface tension of the materials. The difficulty of adhesion causes separation between an alloy resistance film and the substrate. In particular, when the power is increased or the temperature is increased, the alloy resistance film is more likely to peel off due to thermal expansion and contraction.

### SUMMARY

Thus, the purpose of the invention is to provide a high-power thin film resistor. The high-power thin film resistor includes a substrate, a resistance layer, an internal electrode layer, a passivation layer and a thermal conductive layer. The resistance layer is disposed on the substrate, wherein the resistance layer includes a middle internal resistance area and two terminal resistance areas. The internal electrode layer is disposed on the resistance layer, wherein the internal electrode layer includes a middle internal electrode area and two terminal internal electrode areas, the middle internal electrode area and the two terminal internal electrode areas divide the resistance layer into the middle resistance area and the two terminal resistance areas. The passivation layer covers portions of the resistance layer and the internal electrode layer. The thermal conductive layer is disposed on the passivation layer, wherein the thermal conductive layer includes two thermal conductors and a gap between the two thermal conductors, and the two thermal conductors contact the two terminal internal electrode areas of the internal electrode layer respectively. Among them, the middle resistance area and the two terminal resistance areas form a series resistance, and the two terminal resistance areas have the same resistance value.

According to an embodiment of the invention, each of the middle resistance area and the two terminal resistance areas includes a resistance trimming area. The resistance trimming area is under an area covered by the two thermal conductors of the thermal conductive layer.

According to an embodiment of the invention, the high-power thin film resistor further includes a dorsal internal electrode layer. The dorsal internal electrode layer is disposed on the other side of the substrate relative to a side of the resistance layer.

According to an embodiment of the invention, the high-power thin film resistor further includes two connection layers. The two connection layers are disposed at two terminals of the substrate respectively and are connected to the dorsal internal electrode layer, the internal electrode layer and the thermal conductive layer on the two terminals.

According to an embodiment of the invention, the high-power thin film resistor further includes two external electrode layers. The two external electrode layers have an external electrode thermal layer, and the two external electrode layers cover corresponding side walls of the thermal conductive layer and the internal electrode layer respectively.

According to an embodiment of the invention, each of the two terminal resistance areas is a double bend pattern surrounding the corresponding one of the two terminal internal electrode areas.

Another purpose of the invention is to provide a method of manufacturing a high-power thin film resistor, including: depositing a resistance layer on the substrate; forming a patterned photoresist layer on the resistance layer; forming an internal electrode layer on the patterned photoresist layer; removing the patterned photoresist layer to form a middle internal electrode area and two terminal internal electrode areas of the internal electrode layer, and to expose a middle resistance area and two terminal resistance areas of the resistance layer below the internal electrode layer, wherein the middle resistance area and the two terminal resistance areas form a series resistance, and the two terminal resistance areas have the same resistance value; forming a passivation layer on portions of the resistance layer and the internal electrode layer; and forming a thermal conductive layer on the passivation layer, wherein the thermal conductive layer is formed with two thermal conductors and a gap between the two thermal conductors, and the two thermal conductors contact the two terminal internal electrode areas of the internal electrode layer respectively.

According to an embodiment of the invention, the method further includes: forming a resistance trimming area at each of the middle resistance area and the two terminal resistance areas, wherein the resistance trimming area is under an area covered by the two thermal conductors of the thermal conductive layer.

According to an embodiment of the invention, the method further includes: forming a dorsal internal electrode layer on the other side of the substrate relative to a side of the resistance layer.

According to an embodiment of the invention, the method further includes: forming two external electrode layers, wherein the two external electrode layers have an external electrode thermal layer, and the two external electrode layers cover corresponding side walls of the thermal conductive layer and the internal electrode layer respectively.

### BRIEF DESCRIPTION OF THE DRAWINGS

In order to make the above and other objects, features, advantages and embodiments of the invention easier to understand, the accompanying drawings are described as following.

FIG. 1A is a stacked structure diagram of each layer of a high-power thin film resistor from a bottom view according to some embodiments of the invention.

FIG. 1B is a cross-sectional view diagram of a high-power thin film resistor taken along line A-A′ depicted in FIG. 1A according to some embodiments of the invention.

FIG. 2A is a top view diagram of the resistance layer and the internal electrode layer of the high-power thin film resistor according to some embodiments of the invention.

FIG. 2B is a schematic diagram of an equivalent resistance of the resistance layer of the high-power thin film resistor according to some embodiments of the invention.

FIG. 3 is a top perspective view diagram of a thermal conductive layer and a resistance layer of the high-power thin film resistor according to some embodiments of the invention.

FIG. 4 is a flow diagram of a manufacturing method for manufacturing the high-power thin film resistor according to some embodiments of the invention.

FIG. 5A to FIG. 5M illustrate cross-sectional view diagrams of the high-power thin film resistor manufactured by the manufacturing method shown in FIG. 4 at various manufacturing stages.

### DETAILED DESCRIPTION

The following disclosure provides many different embodiments or examples for implementing different features of the provided subject matter. Embodiments of components and configurations described below are examples only and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Secondly, in order to clearly present the features of the invention, the dimensions (such as length, width, thickness and depth) of the elements (such as layers, films, substrates, regions, etc.) in the drawings are not drawn in scale. Therefore, the description and explanation of the embodiments below are not limited to the sizes and shapes of the components in the drawings, but should cover the sizes, shapes, and deviations caused by actual manufacturing processes and/or tolerances. For example, flat surfaces shown in the drawings may have rough and/or non-linear features, and sharp angles shown in the drawings may be rounded. That is to say, the components shown in the drawings of the invention are mainly for illustration and are not intended to accurately depict the actual shapes of the components, nor are intended to limit the scope of the invention.

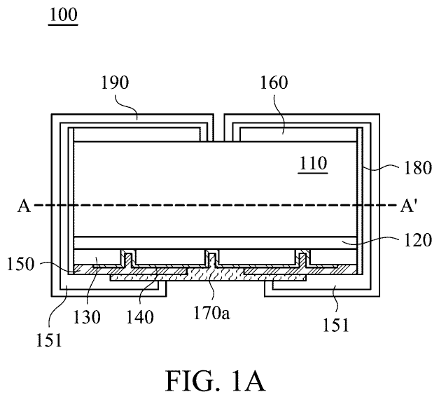

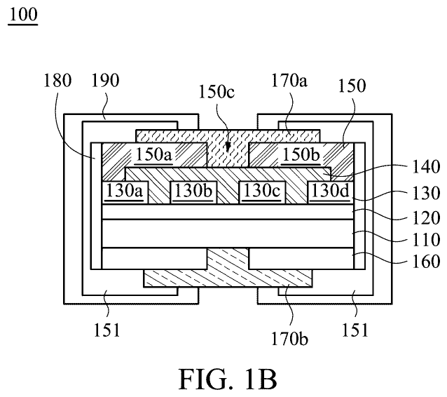

Please refer to FIG. 1A and FIG. 1B. FIG. 1A is a stacked structure diagram of each of the layers of a high-power thin film resistor 100 from a bottom view according to some embodiments of the invention. FIG. 1B is a cross-sectional view diagram of the high-power thin film resistor 100 taken along line A-A′ depicted in FIG. 1A according to some embodiments of the invention. The high-power thin film resistor 100 includes a substrate 110, a resistance layer 120, an internal electrode layer 130, a passivation layer 140, a thermal conductive layer 150, a dorsal internal electrode layer 160, a plurality of protection layers 170 (such as a first protection layer 170a and a second protection layer 170b), two connection layers 180 and two external electrodes 190.

As shown in FIG. 1B, the resistance layer 120 is disposed on the substrate 110, the internal electrode layer 130 is disposed on the resistance layer 120. The internal electrode layer 130 includes two terminal internal electrode areas 130a, 130d and middle internal electrode areas 130b, 130c. The passivation layer 140 covers portions of the resistance layer 120 and the internal electrode layer 130. The thermal conductive layer 150 is disposed on the passivation layer 140, and contacts the two terminal internal electrode areas 130a, 130d of the internal electrode layer 130. In this way, the heat generated by the high-power thin film resistor 100 can be directly conducted from the two terminal internal electrode areas 130a, 130d to the thermal conductive layer 150, and then the thermal conductive layer 150 conducts the heat to the two connection layers 180, the external electrodes 190 and external circuits or printed circuit boards. In addition, portions of the surface of the thermal conductive layer 150 and the dorsal internal electrode layer 160 are covered by the protection layers 170. The two connection layers 180 connect the corresponding side walls of the substrate 110, the resistance layer 120, the internal electrode layer 130, the thermal conductive layer 150 and the dorsal internal electrode layer 160 on both terminals respectively, and these layers are finally covered by the two external electrodes 190 from the outermost layer.

The material of the substrate 110 can be aluminum oxide, aluminum nitride, FR-4, polyimide (PI), silicon dioxide (SiO₂), etc., and the invention is not limited thereto.

The resistance value of the resistance layer 120 can be adjusted through laser trimming or physical processes to obtain the required target resistance value. In the embodiment, the material of the resistance layer 120 can be copper manganese alloy (MnCu), copper nickel alloy (CuNi), copper manganese nickel alloy (CuMnNi), copper manganese tin alloy (CuMnSn), nickel chromium aluminum alloy (NiCrAl), nickel chromium aluminum silicon alloy (NiCrAlSi), iron chromium aluminum alloy (FeCrAl), or other metal alloys, and the invention is not limited thereto.

The passivation layer 140 can transform the metal surface into a state that is not easily oxidized to slow down the corrosion speed of the metal, thereby protecting the underlying resistance layer 120 and the internal electrode layer 130. The material of the passivation layer 140 can be one or more layers of silicon dioxide (SiO₂), silicon nitride (SiN), silicon oxynitride (SiON), tantalum oxide (Ta₂O) or other insulating oxides, and the invention is not limited thereto.

The thermal conductive layer 150 has two thermal conductors 150a, 150b, and there is a gap 150c between the thermal conductors 150a, 150b. Therefore, the thermal conductors 150a, 150b do not contact each other (that is, they are disconnected and do not provide a conductive path). The thermal conductive layer 150 is composed of a metal material with high thermal conductivity (such as copper or aluminum), so that the heat generated by the resistance layer 120 can be dissipated faster, thereby improving the power withstanding capability of the high-power thin film resistor 100.

The protection layers 170 protect the thermal conductive layer 150 and the dorsal internal electrode layer 160 from environmental pollution or oxidation, thereby achieving the effects of insulation and protection. The material of the protection layers 170 includes but not limited to epoxy resin, polyimide, acrylic resin or other insulating materials. In the embodiment, the first protection layer 170a covers the passivation layer 140 and part of the upper surface of the thermal conductive layer 150. The second protection layer 170b covers the substrate 110 and part of the surface of the dorsal internal electrode layer 160.

The two connection layers 180 connect the corresponding side walls of the substrate 110, the resistance layer 120, the internal electrode layer 130, the thermal conductive layer 150 and the dorsal internal electrode layer 160. The two external electrodes 190 extend from the surface of the first protection layer 170a to the surface of the second protection layer 170b to cover both terminals of these layers. The structures of the two external electrodes 190 include a copper metal layer 151, a nickel metal layer and a tin metal layer formed sequentially by electroplating processes. Among them, the copper metal layer 151 is used as another thermal conductive layer that improves the thermal conductivity speed of the high-power thin film resistor 100. The outermost tin metal layer provides soldering and adhesion functions between the high-power thin film resistor 100 and external circuit boards.

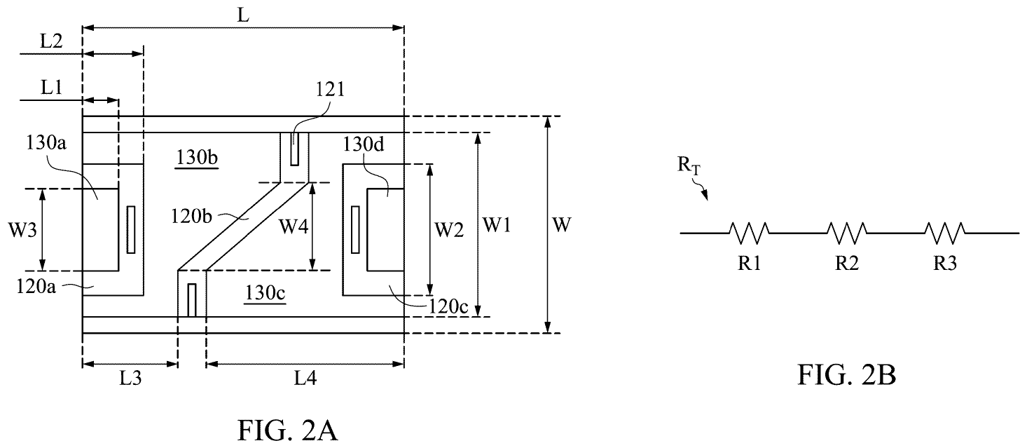

In FIG. 2A, a top view diagram of the resistance layer 120 and the internal electrode layer 130 of the high-power thin film resistor 100 according to some embodiments of the invention is further illustrated. The internal electrode layer 130 includes the two terminal internal electrode areas 130a, 130d and the middle internal electrode areas 130b, 130c, which divide the resistance layer 120 into two terminal resistance areas 120a, 120c and the middle resistance area 120b. The two terminal resistance areas 120a, 120c are close to the two terminal internal electrode areas 130a, 130d. The two terminal resistance areas 120a, 120c and the middle resistance area 120b all include at least one resistance trimming area 121. The resistance trimming areas 121 are used to adjust resistance values to obtain the target resistance value of each of the resistance areas. In the embodiment, the two terminal resistance areas 120a, 120c are designed to be a double bend pattern and the middle resistance area 120b is designed to be a diagonal pattern, increasing the width of the cross-sectional area in the resistance formula, thereby achieving a lower target resistance value.

In a preferred embodiment of the invention, the length of the substrate 110 of the high-power thin film resistor 100 is L, the length L1 of the two terminal internal electrode areas 130a, 130d is less than the length L2, and the length L2 is less than ¼L; the length L3 is in the range of ¼L to ⅓L; the length L4 is in the range of ½L to ⅗L. The width of the high-power thin film resistor 100 is W, the width W1 is in the range of ⅘W to 9/10W; the width W2 is in the range of ⅗W to ¾W; the width W3 is the width of the two terminal internal electrode areas 130a and 130d, and is in the range of ⅓W to ½W; the width W4 is in the range of ½W1 to ¾W1.

FIG. 2B further illustrates a schematic diagram of an equivalent resistance of the resistance layer 120 of the high-power thin film resistor 100 according to some embodiments of the invention. The total resistance value R_{T} of the high-power thin film resistor 100 can be equivalent to a series resistance of the two terminal resistance areas 120a, 120c and the middle resistance area 120b. In the embodiment of the invention, the resistance value of the two terminal resistance area 120a is R1, the resistance value of the middle resistance area 120b is R2, and the resistance value of the two terminal resistance area 120c is R3. The resistance value R1 of the two terminal resistance area 120a is equal to the resistance value R3 of the two terminal resistance area 120c, so that the heat generated by the resistance layer 120 can be evenly distributed throughout the high-power thin film resistor 100, and more than 50% of the heat can be directly conducted to external circuits from the two terminal internal electrode areas 130a, 130d of the internal electrode layer 130. In some preferred embodiments of the invention, the design interval of the resistance values R1, R2 and R3 is ¼R≤R1=R3≤⅓R.

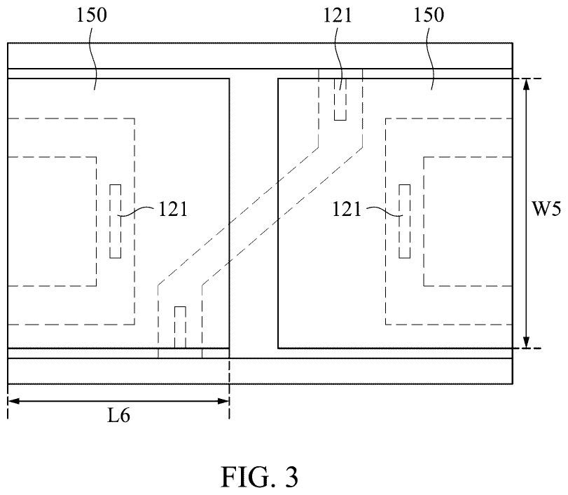

FIG. 3 further illustrates a top perspective view diagram of the thermal conductive layer 150 and the resistance layer 120 of the high-power thin film resistor 100 according to some embodiments of the invention. The thermal conductive layer 150 is disposed on the side of the resistance layer 120 with the resistance trimming areas 121, and the resistance trimming areas 121 of the two terminal resistance areas 120a, 120c and the middle resistance area 120b are under an area of the thermal conductive layer 150. Since the resistance trimming areas 121 are usually heat-concentrated areas, placing the resistance trimming area 121 under the area of the thermal conductive layer 150 is beneficial to the overall heat dissipation for the high-power thin film resistor 100. Therefore, the heat generated by the resistance trimming areas 121 can be directly conducted to the thermal conductive layer 150 through the passivation layer 140, and then conducted to the external circuits through the thermal conductive layer 150. In the embodiment of the invention, the width of the high-power thin film resistor 100 is W, the length of the high-power thin film resistor 100 is L, the width of the thermal conductive layer 150 is W5, the length of the thermal conductive layer 150 is L6. The width W5 is in the range of ⅘W to 9/10W, the length L6 is in the range of ⅓L to 9/10L, which covers the resistance trimming areas 121 of the two terminal resistance areas 120a, 120c and the middle resistance area 120b of the resistance layer 120.

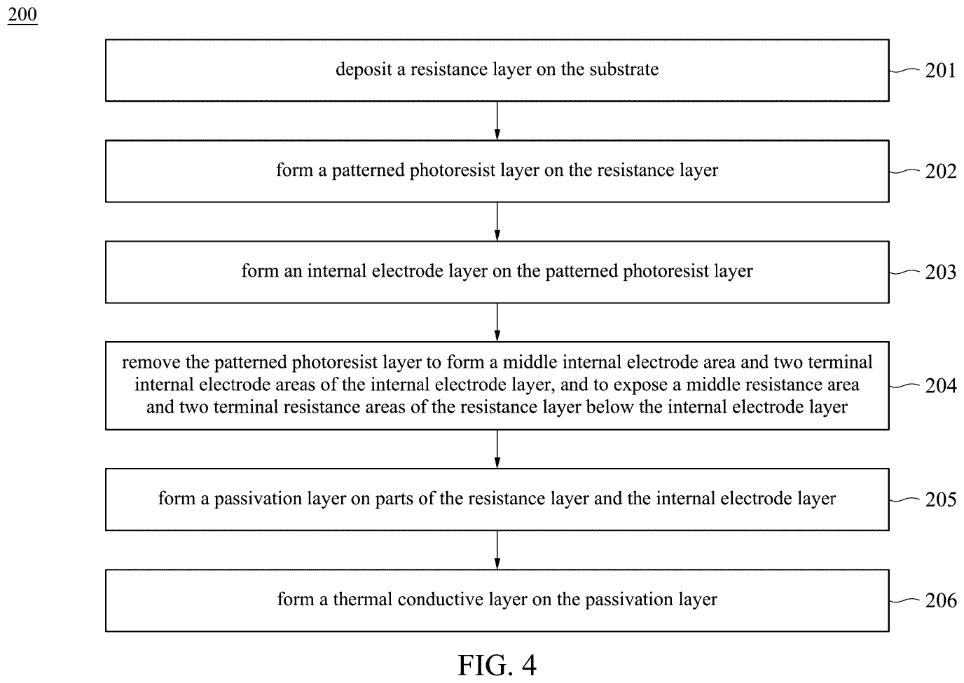

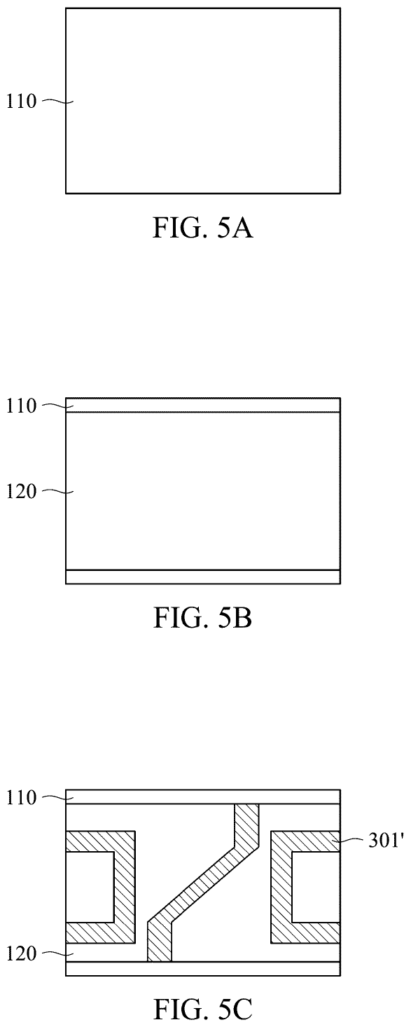

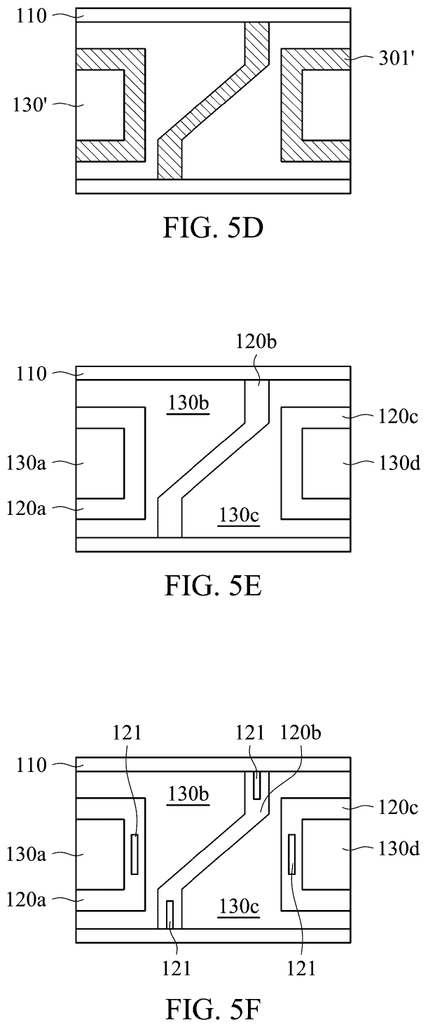

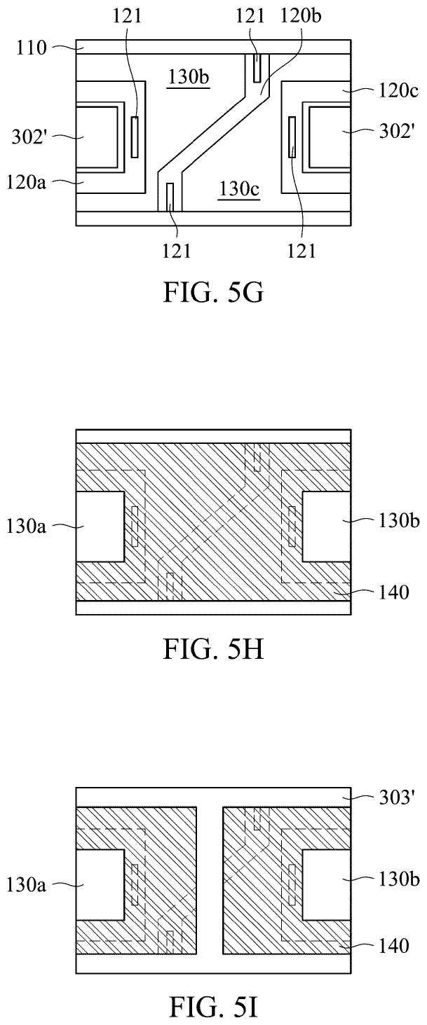

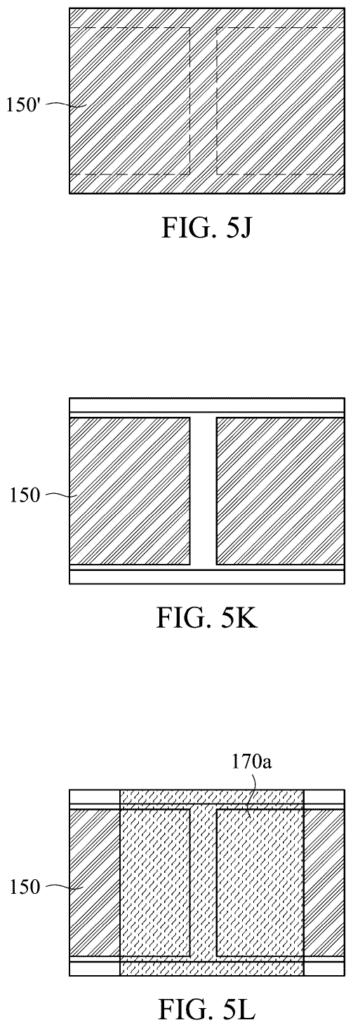

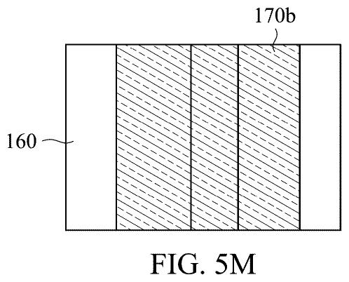

Please refer to FIG. 4, FIG. 4 is a flow diagram of a manufacturing method 200 for manufacturing the high-power thin film resistor according to some embodiments of the invention. The manufacturing method 200 can be implemented by the high-power thin film resistor 100 shown in FIG. 1B, or can be implemented by similar structures that can achieve similar functions. The manufacturing method 200 of FIG. 4 is described with the high-power thin film resistor 100 shown in FIG. 1B and FIGS. 5A to 5M. FIGS. 5A to 5M illustrate cross-sectional view diagrams of the high-power thin film resistor 100 manufactured by the manufacturing method 200 shown in FIG. 4 at various manufacturing stages.

It should be understood that the manufacturing method 200 is non-limiting example. Although only some operations are briefly described herein, in fact other additional operations may be included before, during, or after the manufacturing method 200 shown in FIG. 4. In addition, the order of operations provided by the manufacturing method 200 is not intended to be limiting. In fact, some operations can be performed in a different order, and some additional operations can also be appropriately modified.

The manufacturing method 200 includes steps 201 to 206. Please refer to FIG. 4, FIG. 5A and FIG. 5B (corresponding to step 201). First, the substrate 110 is provided, and the resistance layer 120 is deposited on the substrate 110 by a sputtering processes.

Please refer to FIG. 4 and FIG. 5C (corresponding to step 202), covering a layer of patterned and removable anti-plating layer 301′ on the resistance layer 120 by printing or lithography processes. The patterned anti-plating layer 301′ can also be a photoresist layer, a removable adhesive film or ink, etc., the invention is not limited thereto.

Please refer to FIG. 4, FIG. 5D and FIG. 5E (corresponding to steps 203 and 204), forming a electroplating layer 130′ on the resistance layer 120 by using electroplating processes, in which the material of the electroplating layer 130′ is, for example, copper. Next, removing the patterned anti-plating layer 301′ (the patterned photoresist layer) to make the electroplating layer 130′ formed into an internal electrode layer 130 having the two terminal internal electrode areas 130a, 130d and the middle internal electrode areas 130b, 130c by using a stripping solvent or water washing processes. The resistance layer 120 underneath is exposed where the patterned anti-electroplating layer 301′ is removed, so that the resistance layer 120 has the two terminal resistance areas 120a, 120c and the middle resistance area 120b. The two terminal resistance areas 120a, 120c are close to the two terminal internal electrode areas 130a, 130d.

Please refer to FIG. 5F, the required target resistance value is then obtained in the resistance trimming areas 121 (the resistance value of the two terminal resistance area 120a is R1, the resistance value of the middle resistance area 120b is R2, and the resistance value of the two terminal resistance area 120c is R3) by using laser trimming or physical processes to adjust the resistance value of the two terminal resistance areas 120a, 120c and the middle resistance area 120b. As shown in Figure, the resistance trimming process cuts the two terminal resistance areas 120a, 120c and the middle resistance area 120b to form a plurality of grooves (ie, the resistance trimming areas 121) thereon.

Please refer to FIG. 5G, printing or photolithography processes is then used to cover the two terminal internal electrode areas 130a, 130d with a layer of patterned and removable photoresist 302′. The patterned photoresist 302′ can also be a removable film or ink, and the invention is not limited thereto.

Please refer to FIG. 4 and FIG. 5H (corresponding to step 205), the passivation layer 140 is deposited on the resistance layer 120 and the internal electrode layer 130 by using sputtering or chemical vapor deposition (CVD). Next, the patterned photoresist 302′ is removed by using a stripping solvent or water washing to expose the two terminal internal electrode areas 130a, 130d.

Please refer to FIG. 5I, a layer of I-shaped and removable patterned photoresist 303′ is covered on the passivation layer 140 by printing or photolithography process. This patterned photoresist 303′ can also be a removable film or ink., the invention is not limited thereto.

Please refer to FIG. 4, FIG. 5J and FIG. 5K (corresponding to step 206), one or more copper layers 150′ are sputtered on the passivation layer 140 and the patterned photoresist 303′ by using sputtering process. Next, the patterned photoresist 303′ is removed by using a stripping solvent or water washing, so that the copper layer 150′ is formed into the thermal conductive layer 150.

Please refer to FIG. 5L, the first protection layer 170a is formed on part of the upper surface of the thermal conductive layer 150 by printing, lamination, or photolithography process.

Please refer to FIG. 5M, the dorsal internal electrode layer 160 and the second protection layer 170b are formed on the backside of the substrate 110 in a manner similar to the formation of the internal electrode layer 130 and the first protection layer 170a.

In embodiments of the invention, the two connection layers 180 are also formed by sputtering to connect corresponding side walls of the substrate 110, the resistance layer 120, the internal electrode layer 130, the thermal conductive layer 150 and the dorsal internal electrode layer 160. Finally, the copper metal layer 151, the nickel metal layer, the tin metal layer, etc are formed sequentially by electroplating processes. By now, the high-power thin film resistor 100 is basically completed.

According to the high-power thin film resistor and its manufacturing method of the invention, the achievable effects include: the resistance layer has the middle internal electrode area and the two terminal resistance areas close to the two terminal internal electrode areas, wherein the resistance values of the two terminal resistance areas are designed to be equal, so that the heat generated by the resistance layer can be evenly distributed throughout the high-power thin film resistor, and more than 50% of the heat can be directly conducted from the two terminal internal electrode areas of the internal electrode layer to the external circuits; the thermal conductive layer is disposed on the upper side of the resistance layer, and the resistance trimming area of the resistance layer are all covered under the area of the thermal conductive layer, which are beneficial for the heat generated in the resistance trimming area can be directly conducted to the thermal conductive layer through the passivation layer, thereby increasing the heat dissipation rate; the thermal conductive layer is in direct contact with the underlying internal electrode at both terminals to increase the heat dissipation rate; the two terminal resistance areas are designed to be a double bend pattern and the middle resistance area is designed to be a diagonal pattern, which increases the width of the cross-sectional area in the resistance formula, thereby achieving a lower target resistance value. In summary, the high-power thin film resistor of the invention not only improves the overall heat dissipation efficiency of the resistor, but also increases the withstand power range of the resistor.

Although the invention has been disclosed in the above embodiments, it is not intended to limit the invention. Anyone with ordinary knowledge in this technical field can make various changes and modifications without departing from the spirit and scope of the invention. Therefore, the scope of the invention shall be determined by the appended patent application scope.

What is claimed is:

1. A high-power thin film resistor, comprising:
a substrate;
a resistance layer disposed on the substrate, wherein the resistance layer includes a middle resistance area and two terminal resistance areas;
an internal electrode layer disposed on the resistance layer, wherein the internal electrode layer includes a middle internal electrode area and two terminal internal electrode areas, the middle internal electrode area and the two terminal internal electrode areas divide the resistance layer into the middle resistance area and the two terminal resistance areas;
a passivation layer covering portions of the resistance layer and the internal electrode layer; and
a thermal conductive layer disposed on the passivation layer, wherein the thermal conductive layer includes two thermal conductors and a gap between the two thermal conductors, and the two thermal conductors contact the two terminal internal electrode areas of the internal electrode layer respectively;
wherein the middle resistance area and the two terminal resistance areas form a series resistance, and the two terminal resistance areas have the same resistance value.

2. The high-power thin film resistor of claim 1, wherein each of the middle resistance area and the two terminal resistance areas includes:
a resistance trimming area, wherein the resistance trimming area is under an area covered by the two thermal conductors of the thermal conductive layer.

3. The high-power thin film resistor of claim 1, further comprising:
a dorsal internal electrode layer disposed on the other side of the substrate relative to a side of the resistance layer.

4. The high-power thin film resistor of claim 3, further comprising:
a protection layer covering the substrate and portions of upper surface of the dorsal internal electrode layer.

5. The high-power thin film resistor of claim 3, further comprising:
two connection layers disposed at two terminals of the substrate respectively and are connected to the dorsal internal electrode layer, the internal electrode layer and the thermal conductive layer on the two terminals.

6. The high-power thin film resistor of claim 5, further comprising:
two external electrode layers having an external electrode thermal layer, wherein the two external electrode layers cover corresponding side walls of the thermal conductive layer and the internal electrode layer respectively.

7. The high-power thin film resistor of claim 6, wherein each of the two external electrode layers further includes a nickel metal layer and a tin metal layer.

8. The high-power thin film resistor of claim 1, further comprising:
a protection layer covering the passivation layer and portions of upper surface of the thermal conductive layer.

9. The high-power thin film resistor of claim 1, wherein each of the two terminal resistance areas is a double bend pattern surrounding the corresponding one of the two terminal internal electrode areas.

10. A method of manufacturing a high-power thin film resistor, comprising:
depositing a resistance layer on a substrate;
forming a patterned photoresist layer on the resistance layer;
forming an internal electrode layer on the patterned photoresist layer;
removing the patterned photoresist layer to form a middle internal electrode area and two terminal internal electrode areas of the internal electrode layer, and to expose a middle resistance area and two terminal resistance areas of the resistance layer below the internal electrode layer, wherein the middle resistance area and the two terminal resistance areas form a series resistance, and the two terminal resistance areas have the same resistance value;
forming a passivation layer on portions of the resistance layer and the internal electrode layer; and
forming a thermal conductive layer on the passivation layer, wherein the thermal conductive layer is formed with two thermal conductors and a gap between the two thermal conductors, and the two thermal conductors contact the two terminal internal electrode areas of the internal electrode layer respectively.

11. The method of claim 10, further comprising:
forming a resistance trimming area at each of the middle resistance area and the two terminal resistance areas, wherein the resistance trimming area is under an area covered by the two thermal conductors of the thermal conductive layer.

12. The method of claim 10, further comprising:
forming a dorsal internal electrode layer on the other side of the substrate relative to a side of the resistance layer.

13. The method of claim 12, further comprising:
forming two connection layers at two terminals of the substrate respectively, wherein the two connection layers are connected to the dorsal internal electrode layer, the internal electrode layer and the thermal conductive layer on the two terminals.

14. The method of claim 10, further comprising:
forming two external electrode layers, wherein the two external electrode layers include an external electrode thermal layer, and the two external electrode layers cover corresponding side walls of the thermal conductive layer and the internal electrode layer respectively.

15. The method of claim 10, wherein each of the two terminal resistance areas has a double bend pattern surrounding the corresponding one of the two terminal internal electrode areas.

16. The method of claim 10, wherein the middle resistance area has a diagonal pattern.
